(19) United States
(12) Patent Application Publication
(10) Pub. No.: US 2017/0081585 A1
(43) Pub. Date: Mar. 23, 2017

(54) Method of Diversion and Zonal Isolation in a Subterranean Formation Using a Biodegradable Polymer

(71) Applicant: BAKER HUGHES INCORPORATED, HOUSTON, TX (US)

(72) Inventors: NAIMA BESTAOUI-SPURR, THE WOODLANDS, TX (US); FRANCES H. DEBENEDICTIS, HOUSTON, TX (US); DORIANNE CASTILLO, HUMBLE, TX (US)

(73) Assignee: BAKER HUGHES INCORPORATED, HOUSTON, TX (US)

(21) Appl. No.: 14/859,050

(22) Filed: Sep. 18, 2015

(51) Int. Cl. C09K 8/70; E21B 43/26; E21B 43/267; C09K 8/68; C09K 8/88

(52) U.S. Cl. CPC C09K 8/70; C09K 8/68; C09K 8/885; E21B 43/267; E21B 43/26

(57) ABSTRACT

Various methods for redirecting a well treatment fluid to targeted zones of a subterranean formation within a reservoir and diverting the fluid away from high permeability or undamaged zones of the formation by temporarily blocking the high permeability zones are provided. A well treatment fluid can be diverted from a high permeability or undamaged zone of a formation within a reservoir having a high bottomhole temperature by introducing into the reservoir a biodegradable polymer that has excellent heat resistance.

### BACKGROUND

It is known in the art that hydraulic fracturing can be utilized to extract hydrocarbons from subterranean formations. There can be multiple potential producing zones within a single wellbore in a subterranean formation to be fractured. Often times, it is desirable to isolate these zones from one another to divert fluid flow and stimulate the well more effectively.

Various types of materials and techniques have been utilized for this purpose. For example, particulates have been used in treatment fluids as a fluid loss control agent and/or diverting agent to fill and seal the pore spaces and fractures in the subterranean formation or to contact the surface of a formation face or proppant pack, thereby forming a filter cake that blocks the pore spaces and fractures for purposes of diversion or zonal isolation.

These previous materials and techniques have a number of disadvantages. For example, they do not have the desired properties and effectiveness at higher temperatures within the subterranean formation. Improvements in this field of technology are therefore desired.

### SUMMARY

The presently disclosed subject matter relates generally to methods of redirecting well treatment fluids from high permeability zones to low permeability zones of a subterranean formation using biodegradable polymers suitable for higher temperature operations.

In certain illustrative embodiments, a method of stimulating a subterranean formation penetrated by a reservoir is provided. A fluid comprising a biodegradable copolymer is introduced into a reservoir, the copolymer having the general formula of repeating units [—CHR—CH₂—CO—O—] wherein R represents an alkyl group represented by CₙH₂ₙ₊₁, and n is 1 and 3. The biodegradable copolymer can be a copolymer of 3-hydroxybutyrate having at least one monomer of hydroxyhexanoate. The copolymer can be poly-3-hydroxybutyrate-co-3-hydroxyhexanoate. The downhole temperature of the reservoir can be about 250° F. The downhole temperature of the reservoir can be greater than about 250° F. The downhole temperature of the reservoir can be greater than about 275° F. The fluid can further include a carrier fluid. The biodegradable polymer can be in particulate form and can have a particulate size distribution in the range from about 4 mesh to about 140 mesh. The biodegradable polymer can be utilized in connection with an acid stimulation operation.

In certain illustrative embodiments, a method of stimulating the production of hydrocarbons from a subterranean formation penetrated by a wellbore is provided. A mixture can be flowed into a high permeability zone of a fracture within a subterranean formation near the wellbore. The mixture can include a dissolvable diverter and a proppant, wherein the dissolvable diverter includes a biodegradable copolymer having the general formula of repeating units [—CHR—CH₂—CO—O—] wherein R represents an alkyl group represented by CₙH₂₊₁, and n is 1 and 3. At least a portion of the high permeability zone can be propped open with the proppant of the mixture. At least a portion of the high permeability zone can be blocked with the diverter. A fluid can be pumped into the subterranean formation and into a lower permeability zone of the formation farther from the wellbore. The diverter blocking at least a portion of the high permeability zone near the wellbore can be dissolved while the proppant remains present within the high permeability zone. Hydrocarbons can be produced from the high permeability zone and the lower permeability zone The biodegradable copolymer can be a copolymer of 3-hydroxybutyrate having at least one monomer of hydroxyhexanoate. The copolymer can be poly-3-hydroxybutyrate-co-3-hydroxyhexanoate. The downhole temperature of the reservoir can be about 250° F. The downhole temperature of the reservoir can be greater than about 250° F. The downhole temperature of the reservoir can be greater than about 275° F. The biodegradable polymer can be in particulate form and can have a particulate size distribution in the range from about 4 mesh to about 140 mesh. The proppant can have a specific gravity of 2.45 or less. The weight percent of proppant in the mixture can be in the range from 2% to 90%. The weight percent of proppant in the mixture can be in the range from 4% to 70%. The dissolvable diverter and the proppant can be in particulate form, and at least some of the dissolvable diverter particulates can be larger than the proppant particulates. The size distribution of the dissolvable diverter particulates and the proppant particulates can be sufficient to minimize permeability. The biodegradable polymer can be utilized in connection with an acid stimulation operation.

In certain illustrative embodiments, a method of enhancing the productivity of fluid from a well penetrating a subterranean formation is provided. A first fluid can be pumped into the subterranean formation at a pressure sufficient to create or enhance a fracture near the wellbore. The first fluid can include a mixture of a diverter and a proppant wherein the diverter is dissolvable at in-situ conditions by producing fluid from the well. The diverter can include a biodegradable copolymer having the general formula of repeating units [—CHR—CH₂—CO—O—] wherein R represents an alkyl group represented by CₙH₂ₙ₊₁, and n is 1 and 3. The first fluid can be flowed into a high permeability zone of the fracture. At least a portion of the high permeability zone can be propped with the proppant of the mixture. At least a portion of the high permeability zone can be blocked with the diverter. A second fluid can be pumped into the subterranean formation and into a lower permeability zone of the subterranean formation farther from the wellbore. The diverter blocking at least a portion of the high permeability zone near the wellbore can be dissolved at in-situ reservoir conditions while the proppant remains present within the high permeability zone. Fluid can be produced from the high permeability zone and the lower permeability zone. The biodegradable copolymer can be a copolymer of 3-hydroxybutyrate having at least one monomer of hydroxyhexanoate. The copolymer can be poly-3-hydroxybutyrate-co-3-hydroxyhexanoate. The downhole temperature of the reservoir can be about 250° F. The downhole temperature of the reservoir can be greater than about 250° F. The downhole temperature of the reservoir can be greater than about 275° F. The biodegradable polymer can be in particulate form and can have a particulate size distribution in the range from about 4 mesh to about 140 mesh. The proppant can have a specific gravity of 2.4 or less. The weight percent of proppant in the mixture can be in the range from 2% to 90%. The weight percent of proppant in the mixture can be in the range from 4% to 70%. The dissolvable diverter and the proppant can be in particulate form, and at least some of the dissolvable diverter particulates can be larger than the proppant particulates. The size distribution of the dissolvable diverter particulates and the proppant particulates can be sufficient to minimize permeability. The biodegradable polymer can be utilized in connection with an acid stimulation operation, wherein the first fluid can comprise an acidizing fluid. The biodegradable polymer can also be utilized in connection with a fracturing operation, wherein the first fluid can comprise a fracturing fluid. The fracturing fluid can include an aqueous carrier fluid, a cross-linkable gel polymer soluble in the aqueous carrier fluid and a cross-linking agent. The fracturing fluid can include an aqueous carrier fluid, a cross-linkable gel polymer soluble in the aqueous carrier fluid, a cross-linking agent, a linear gel and a surfactant gel. The aqueous carrier fluid can comprise one or more of water, salt brine and slickwater.

In certain illustrative embodiments, a method of stimulating a subterranean formation penetrated by a wellbore is provided. A casing within the wellbore can be perforated to provide a channel near the wellbore extending from the casing into the subterranean formation. A fluid can be pumped at a pressure sufficient to create or enlarge a fracture near the wellbore in the subterranean formation. The fluid can include a mixture of a diverter and a proppant. The diverter can be dissolvable at in-situ conditions. The diverter can include a biodegradable copolymer having the general formula of repeating units [—CHR—CH₂—CO—O—] wherein R represents an alkyl group represented by CₙH₂ₙ₊₁, and n is 1 and 3. The mixture can be flowed into a high permeability zone within the fracture near the wellbore and at least a portion of the high permeability zone can be blocked with the diverter. The sized particulate distribution of the diverter can be sufficient to at least partially block the penetration of a second fluid into the high permeability zone of the formation. The second fluid can be pumped into the subterranean formation and into a lower permeability zone of the formation farther from the wellbore. The diverter can be dissolved near the wellbore at in-situ reservoir conditions while the proppant remains present within the high permeability zone. Fluid can be produced from the high permeability zone containing the proppant of the mixture. The biodegradable copolymer can be a copolymer of 3-hydroxybutyrate having at least one monomer of hydroxyhexanoate. The copolymer can be poly-3-hydroxybutyrate-co-3-hydroxyhexanoate. The downhole temperature of the reservoir can be about 275° F. or greater The biodegradable polymer can be in particulate form and can have a particulate size distribution in the range from about 4 mesh to about 140 mesh. The proppant can have a specific gravity of 2.45 or less. The weight percent of proppant in the mixture can be in the range from 2% to 90%. The weight percent of proppant in the mixture can be in the range from 4% to 70%. The dissolvable diverter and the proppant can be in particulate form, and the average particulate size of dissolvable diverter particulates can be larger than the average particulate size of proppant particulates. The biodegradable polymer can be utilized in connection with an acid stimulation operation.

In certain illustrative embodiments, a method of enhancing the productivity of fluid from the near wellbore region of a well penetrating a subterranean formation is provided. In step (a), a first fluid can be pumped into a high permeability zone of a fracture near the wellbore. The first fluid can include a mixture of a diverter and a proppant. The diverter can be dissolvable at in-situ reservoir conditions. The diverter can include a biodegradable copolymer having the general formula of repeating units [—CHR—CH₂—CO—O—] wherein R represents an alkyl group represented by CₙH₂ₙ₊₁, and n is 1 and 3. In step (b), the mixture of the first fluid can be flowed into the high permeability zone. At least a portion of the high permeability zone can be propped with the proppant of the first mixture, and at least a portion of the high permeability zone can be blocked with the diverter. In step (c), a diverter containing fluid can be pumped into the subterranean formation and into a lower permeability zone of the formation farther from the wellbore. In step (d), a proppant laden fluid can be pumped into the subterranean formation and into a zone of lower permeability of the formation. In step (e), steps (c) and (d) can optionally be repeated. In step (f), the diverter blocking at least portion of the high permeability zone near the wellbore can be dissolved, while the proppant remains present within the high permeability zone. In step (g), fluid can be produced from the high permeability zone and the zone of lower permeability. The biodegradable copolymer can be a copolymer of 3-hydroxybutyrate having at least one monomer of hydroxyhexanoate. The copolymer can be poly-3-hydroxybutyrate-co-3-hydroxyhexanoate. The downhole temperature of the reservoir can be about 275° F. or greater. The biodegradable polymer can be in particulate form and can have a particulate size distribution in the range from about 4 mesh to about 100 mesh. The proppant can have a specific gravity of 2.4 or less. The weight percent of proppant in the mixture can be in the range from 2% to 90%. The weight percent of proppant in the mixture can be in the range from 4% to 70%. The dissolvable diverter and the proppant can be in particulate form, and wherein at least some of the dissolvable diverter particulates can be larger than the proppant particulates. The biodegradable polymer can be utilized in connection with an acid stimulation operation, wherein the first fluid can comprise an acidizing fluid. The biodegradable polymer can also be utilized in connection with a fracturing operation, wherein the first fluid can comprise a fracturing fluid. The fracturing fluid can include an aqueous carrier fluid, a cross-linkable gel polymer soluble in the aqueous carrier fluid and a cross-linking agent. The aqueous carrier fluid can comprise one or more of water, salt brine and slickwater.

While the presently disclosed subject matter will be described in connection with the preferred embodiment, it will be understood that it is not intended to limit the presently disclosed subject matter to that embodiment. On the contrary, it is intended to cover all alternatives, modifications, and equivalents, as may be included within the spirit and the scope of the presently disclosed subject matter as defined by the appended claims.

### BRIEF DESCRIPTION OF THE DRAWINGS

A better understanding of the presently disclosed subject matter can be obtained when the following detailed description is considered in conjunction with the following drawings, wherein:

FIG. 1 is a graph showing the conductivity of LiteProp 175 after diverter was dissolved compared to the conductivity of an unpropped fracture in accordance with an illustrative embodiment of the presently disclosed subject matter.

### DETAILED DESCRIPTION

The presently disclosed subject matter relates to various methods for redirecting a well treatment fluid to targeted zones of a subterranean formation within a reservoir and diverting the fluid away from high permeability or undamaged zones of the formation by temporarily blocking the high permeability zones.

In certain illustrative embodiments, a well treatment fluid can be diverted from a high permeability or undamaged zone of a formation within a reservoir having a high bottomhole temperature by introducing into the reservoir a biodegradable polymer that has excellent heat resistance.

An example of a suitable biodegradable polymer made through a two step enzymatic process is a polyhydroxyalkanoate such as poly (3-hydroxyalkanoate). In an illustrative embodiment, the polymer can be an aliphatic copolymer with a repeating unit represented by the formula: [—CHR—CH₂—CO—O—] (wherein, R represents an alkyl group represented by CₙH₂ₙ₊₁, and n is 1 and 3).

In certain illustrative embodiments, the polymer can be a copolymer of 3-hydroxybutyrate having at least one monomer of hydroxyhexanoate, i.e., poly-3-hydroxybutyrate-co-3-hydroxyhexanoate (also referred to as abbreviation PHBH).

A commercially available example of this polymer is sold by Kaneka Corporation of Osaka, Japan, under the trademark Aonilex®. Aonilex® is an entirely bio-based and biodegradable plastic produced by microorganisms in a specified fermentation condition using plant oils as the carbon source.

In certain illustrative embodiments, the copolymer can have the general formula shown below:

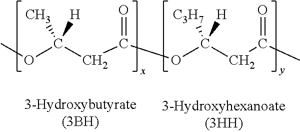

A representative example of this polymer and its formation is described in U.S. Patent Application Publication No. 2011/01900430, published Aug. 4, 2011, and assigned to Kaneka Corporation, the contents and disclosure of which are incorporated by reference herein in their entirety.

In an illustrative embodiment, the biodegradable polymer is effective to block the penetration of the fluid into a high permeability zone or portion of the formation. The flow of the fluid is then diverted to a low permeability zone or portion of the formation.

In another illustrative embodiment, the biodegradable polymer is effective to divert the flow of treatment fluid away from a high permeability zone or portion of the formation. The biodegradable polymer can form bridging solids on the face of the subterranean formation within the reservoir which can help to divert flow at high downhole temperatures.

In certain illustrative embodiments, the downhole temperature of the reservoir can be greater than about 250° F. and preferably greater than about 275° F. The use of the presently disclosed biodegradable polymer is particularly effective under these conditions of high application temperature. The biodegradable polymer has a glass transition temperature well below the application temperature leading to no change in the properties of the material and a more effective and more homogeneous solubilization of the particulates. The low glass transition temperature makes this biodegradable polymer very flexible at the application temperature and more effective at plugging pores.

In certain illustrative embodiments, the biodegradable polymer may be carried or dissolved in a treatment fluid when being applied to the reservoir and/or subterranean formation. For example, the biodegradable polymer can be utilized in connection with an acid stimulation operation, wherein the treatment fluid can comprise an acidizing fluid. The biodegradable polymer can also be utilized in connection with a fracturing operation, wherein the treatment fluid can comprise a fracturing fluid. The fracturing fluid can include an aqueous carrier fluid, a cross-linkable gel polymer soluble in the aqueous carrier fluid and a cross-linking agent.

The treatment fluid containing the biodegradable polymer may be any fluid suitable for transporting the biodegradable polymer into the reservoir and/or subterranean formation and may include carrier fluids such as water, salt brine and slickwater. Suitable brines including those containing potassium chloride, sodium chloride, cesium chloride, ammonium chloride, calcium chloride, magnesium chloride, sodium bromide, potassium bromide, cesium bromide, calcium bromide, zinc bromide, sodium formate, potassium formate, cesium formate, sodium acetate, and mixtures thereof.

In certain illustrative embodiments, the treatment fluid can be a fracturing fluid. The fracturing fluid can comprise, for example, an aqueous fluid such as water, salt brine and slickwater, a cross-linkable gel polymer soluble in the aqueous fluid (including but not limited to guar) and a cross-linking agent along with the biodegradable polymer. Other carriers or treatments that the biodegradable polymer may be embodied in, or added to, can include uncrosslinked/linear gel systems or polymer systems or viscous crosslinked and linear viscous fluid systems. The treatment fluid can also be combined with any additional materials (such as proppants, breakers, surfactants, delay agents or mutual solvents) as appropriate for the particular subterranean formation and/or application, in certain illustrative embodiments.

The presently disclosed polymer and related methods may be utilized with a variety of types of openings found within a subterranean formation. For example, the opening in the subterranean formation can comprise a wellbore, a fracture, and/or a perforation. In general, the presently disclosed subject matter may be utilized with any opening within the subterranean formation that may be plugged or sealed and would result in improved diversion or zonal isolation within the subterranean formation.

Further, the presently disclosed polymer and related methods are not limited to only hydraulic fracturing. In addition, the presently disclosed subject matter may also be utilized with other operations performed in a subterranean formation such as, without limitation, acidizing, drilling and fracturing, gravel packing, workover, fluid loss, wellbore cleanout and frac plug drillout.

In certain illustrative embodiments, the polymer is in the form of particulates, and the particulates are effective when placed into holes having bottom hole temperatures from about 250° F. to about 500° F., and particularly effective when placed into holes having bottom hole temperatures from about 275° F. to about 500° F. The polymer has a very low solubility below 250° F.

The particulates may be of any shape and can have large particulate size distribution. For example, in certain illustrative embodiments, the biodegradable polymer can have a particulate size distribution in the range from about 4 mesh to about 140 mesh. This particulate size distribution is effective because a large distribution of the particulates will result in decreased porosity and better bridging. Further, the particulates can undergo dissolution over time within the subterranean formation.

In certain illustrative embodiments, the polymer and methods described herein can be used to divert the flow of fluid from a high permeability zone to a low permeability zone of a subterranean formation by use of particulates, as described in U.S. Patent Application Publication No. 2014/0352959, published Dec. 4, 2014, assigned to Baker Hughes Incorporated, the contents and disclosure of which are incorporated by reference herein in their entirety.

In certain illustrative embodiments, the polymer and methods described herein can be used to divert the flow of well treatment fluid from a high permeability zone to a low permeability zone of a subterranean formation by use of a mixture of diverting fluid comprising a dissolvable diverter (i.e., the polymer) and a proppant, as described in U.S. Patent Application Publication No. 2015/0041132, published Feb. 12, 2015, assigned to Baker Hughes Incorporated, the contents and disclosure of which are incorporated by reference herein in their entirety.

In certain illustrative embodiments, the diverting fluid can contain diverter particulates and proppant and can enter into a high permeability zone within a fracture network and form a temporary bridge either within the fracture or at the interface of the fracture face and the channels thereof. Over a period of time, the diverters which bridge or plug the fractures dissolve. Those fractures diverted by a fluid containing both diverter particulates and proppant remain open due to the presence of the proppant in the mixture; the proppant not being dissolvable at at-situ reservoir conditions. The production of fluids from such fractures is thereby enhanced. The use of the mixture is particularly of use in those high permeability zones near the wellbore which typically collapse when the diverter dissolves.

In certain illustrative embodiments, the areas in the subterranean formation where the proppant remains in the fracture can become mechanically stronger because the openings are bridged or plugged which provides conductivity that was not previously available, and also allows access to low resistance pathways.

In certain illustrative embodiments where the biodegradable polymer is used along with a proppant, the amount of polymer particulates in the well treatment fluid introduced into the subterranean formation can be between from about 0.01 to about 30 weight percent and the amount of proppant in the well treatment fluid can be between from about 0.01 to about 3% by weight.

The proppant for use in the mixture may be any suitable proppant known in the art and may be deformable or non-deformable at in-situ reservoir conditions and can be, but is not necessarily limited to, white sand, brown sand, ceramic beads, glass beads, bauxite grains, sintered bauxite, sized calcium carbonate, walnut shell fragments, aluminum pellets, nylon pellets, nuts shells, gravel, resinous particles, alumina, minerals, polymeric particles, and combinations thereof. Examples include, but are not limited to, conventional high-density proppants such as quartz, glass, aluminum pellets, silica (sand) (such as Ottawa, Brady or Colorado Sands), synthetic organic particles such as nylon pellets, ceramics (including aluminosilicates), sintered bauxite, and mixtures thereof.

Examples of ceramics include, but are not necessarily limited to, oxide-based ceramics, nitride-based ceramics, carbide-based ceramics, boride-based ceramics, silicide-based ceramics, or a combination thereof. In a non-limiting embodiment, the oxide-based ceramic may include, but is not necessarily limited to, silica (SiO₂), titania (TiO₂), aluminum oxide, boron oxide, potassium oxide, zirconium oxide, magnesium oxide, calcium oxide, lithium oxide, phosphorous oxide, and/or titanium oxide, or a combination thereof. The oxide-based ceramic, nitride-based ceramic, carbide-based ceramic, boride-based ceramic, or silicide-based ceramic may contain a nonmetal (e.g., oxygen, nitrogen, boron, carbon, or silicon, and the like), metal (e.g., aluminum, lead, bismuth, and the like), transition metal (e.g., niobium, tungsten, titanium, zirconium, hafnium, yttrium, and the like), alkali metal (e.g., lithium, potassium, and the like), alkaline earth metal (e.g., calcium, magnesium, strontium, and the like), rare earth (e.g., lanthanum, cerium, and the like), or halogen (e.g., fluorine, chlorine, and the like). Exemplary ceramics include, but are not necessarily limited to, zirconia, stabilized zirconia, mullite, zirconia toughened alumina, spinel, aluminosilicates (e.g., mullite, cordierite), perovskite, silicon carbide, silicon nitride, titanium carbide, titanium nitride, aluminum carbide, aluminum nitride, zirconium carbide, zirconium nitride, iron carbide, aluminum oxynitride, silicon aluminum oxynitride, aluminum titanate, tungsten carbide, tungsten nitride, steatite, and the like, or a combination thereof, as described in U.S. Patent Application Publication No. 2015/0114640, published Apr. 30, 2015, assigned to Baker Hughes Incorporated, the contents and disclosure of which are incorporated by reference herein in their entirety.

Examples of suitable sands for the proppant core include, but are not limited to, Arizona sand, Wisconsin sand, Badger sand, Brady sand, and Ottawa sand. In a non-limiting embodiment, the solid particulate may be made of a mineral such as bauxite and sintered to obtain a hard material. In another non-restrictive embodiment, the bauxite or sintered bauxite has a relatively high permeability such as the bauxite material disclosed in U.S. Pat. No. 4,713,203, the contents and disclosure of which are incorporated by reference herein in their entirety.

In another non-limiting embodiment, the proppant may be a relatively lightweight or substantially neutrally buoyant particulate material or a mixture thereof. By “relatively lightweight” it is meant that the solid particulate has an apparent specific gravity (ASG) which is less than or equal to 2.45, including those ultra lightweight materials having an ASG less than or equal to 2.25, more preferably less than or equal to 2.0, even more preferably less than or equal to 1.75, most preferably less than or equal to 1.25 and often less than or equal to 1.05.

Naturally occurring solid particulates include, but are not necessarily limited to, nut shells such as walnut, coconut, pecan, almond, ivory nut, brazil nut, and the like; seed shells of fruits such as plum, olive, peach, cherry, apricot, and the like; seed shells of other plants such as maize (e.g., corn cobs or corn kernels); wood materials such as those derived from oak, hickory, walnut, poplar, mahogany, and the like. Such materials are particulates which may be formed by crushing, grinding, cutting, chipping, and the like.

Suitable relatively lightweight solid particulates are those disclosed in U.S. Pat. Nos. 6,364,018, 6,330,916 and 6,059,034, the contents and disclosures of each of which are incorporated by reference herein in their entirety.

Other solid particulates for use herein include beads or pellets of nylon, polystyrene, polystyrene divinyl benzene or polyethylene terephthalate such as those set forth in U.S. Pat. No. 7,931,087, the content and disclosure of which is incorporated by reference herein in its entirety.

Fracture proppant sizes may be any size suitable for use in a fracturing treatment of a subterranean formation. It is believed that the optimal size of particulate material relative to fracture proppant material may depend, among other things, on in situ closure stress. For example, a fracture proppant material may be desirable to withstand a closure stress of at least about 1000 psi, alternatively of at least about 5000 psi or greater. However, it will be understood with benefit of this disclosure that these are just optional guidelines. In one embodiment, the proppants used in the disclosed method may have a beaded shape or spherical shape and a size of from about 8 mesh to about 140 mesh, alternatively from about 4 mesh independently to about 100 mesh, alternatively from about 8 mesh independently to about 60 mesh, alternatively from about 12 mesh independently to about 50 mesh, alternatively from about 16 mesh independently to about 40 mesh, and alternatively about 20/40 mesh. Thus, in one embodiment, the proppants may range in size from about 1 or 2 mm independently to about 0.1 mm; alternatively their size will be from about 0.2 mm independently to about 0.8 mm, alternatively from about 0.4 mm independently to about 0.6 mm, and alternatively about 0.6 mm. However, sizes greater than about 2 mm and less than about 0.1 mm are possible as well.

Suitable shapes for proppants include, but are not necessarily limited to, beaded, cubic, bar-shaped, cylindrical, or a mixture thereof. Shapes of the proppants may vary, but in one embodiment may be utilized in shapes having maximum length-based aspect ratio values, in one exemplary embodiment having a maximum length-based aspect ratio of less than or equal to about 25, alternatively of less than or equal to about 20, alternatively of less than or equal to about 7, and further alternatively of less than or equal to about 5. In yet another exemplary embodiment, shapes of such proppants may have maximum length-based aspect ratio values of from about 1 independently to about 25, alternatively from about 1 independently to about 20, alternatively from about 1 independently to about 7, and further alternatively from about 1 independently to about 5. In yet another exemplary embodiment, such proppants may be utilized in which the average maximum length-based aspect ratio of particulates present in a sample or mixture containing only such particulates ranges from about 1 independently to about 25, alternatively from about 1 independently to about 20, alternatively from about 2 independently to about 15, alternatively from about 2 independently to about 9, alternatively from about 4 independently to about 8, alternatively from about 5 independently to about 7, and further alternatively about 7.

In certain illustrative embodiments, the biodegradable polymer and the proppant can both be in particulate form, and the average particulate size of the polymer particulates can be larger than the average particulate size of the proppant particulates. In certain illustrative embodiments, the biodegradable polymer and the proppant will have a wide distribution of particulate sizes which results in good bridging and decreased porosity.

In certain illustrative embodiments, the biodegradable polymer, in the form of dissolvable diverter particulates, can be utilized for diversion purposes in acidizing or acid stimulation operations. In general, acidizing is a type of stimulation treatment that restores the natural permeability of the reservoir rock by pumping acid into the well to dissolve limestone, dolomite and calcite cement between the sediment grains of the reservoir rocks. In certain illustrative embodiments, a treatment fluid containing the biodegradable polymer and proppant may be pumped into the wellbore in alternative stages and may be separate by spacer fluids. The spacer fluid typically contains a salt solution such as NaCl, KCl and/or NH₄Cl. When used in an acid stimulation operation, it may be desirable to alternate the pumping of acid stimulation fluids and the fluid containing the dissolvable polymer particulates and proppant. An exemplary pumping schedule may be (i) pumping an acid stimulation fluid; (ii) optionally pumping a spacer fluid; (iii) pumping a fluid containing the polymer particulates and proppant; (iv) optionally pumping a spacer fluid; and then repeating the cycle of steps (i), (ii), (iii) and (iv).

To facilitate a better understanding of the presently disclosed subject matter, the following examples of certain aspects of certain embodiments are given. In no way should the following examples be read to limit, or define, the scope of the presently disclosed subject matter.

### EXAMPLES

### Example 1

Example 1 shows the solubility of diverters in DI water at various temperatures and as a function of time. The following tests were done using digestion vessels at different temperatures. The solutions were prepared by addition of 16 mL of deionized (“DI”) water and 1 g of sample. After heating for the desired time, the solution was left to cool at room temperature (“RT”). The solution was then filtered through a 41 Whatman paper and washed over no more than 50 mL of DI water. The recovered solid material was left to dry. The percent of material in solution was calculated based on the amount of recovered material.

Table 1 shows the solubility data obtained for Aolinex 131A and Aolinex 151A as a function of temperature and time and as compared to polylactic acid (PLA). It is observed at 250° F. the Aolinex product does not dissolve in water, even after 24 hours while PLA is almost completely dissolved after 24 hours.

When the temperature is increased to 300° F., the tested Aonilex samples show no dissolution after 6 hrs but the majority is dissolved after 24 hrs. This show that these materials can be used at higher temperature than PLA. At 350° F. these materials have the same behavior than at 300° F.

TABLE 1
Solubility of diverters in DI water at various temperatures
as a function of time

| | | |
|---|---|---|
| | | % diverter |
| Time (hrs) | Sample | dissolved |

250° F.

| | | |
|---|---|---|
| 1 | Aonilex X-131A | 0 |
| 2 | Aonilex X-131A | 0.1 |
| 4 | Aonilex X-131A | 0 |
| 6 | Aonilex X-131A | 0 |
| 24 | Aonilex X-131A | 1.87 |
| 1 | PLA | 0.4 |
| 2 | PLA | 1.6 |
| 6 | PLA | 3.2 |
| 24 | PLA | 95.7 |

300° F.

| | | |
|---|---|---|
| 1 | Aonilex X-131A | 0.3 |
| 2 | Aonilex X-131A | 0 |
| 4 | Aonilex X-131A | 0 |
| 6 | Aonilex X-131A | 0 |
| 24 | Aonilex X-131A | 70.5 |
| 24 | Aonilex X-151A | 85.2 |
| 24 | PLA | 100.0 |

350° F.

| | | |
|---|---|---|
| 6 | Aonilex X-131A | 2.41 |
| 6 | Aonilex X-151A | 3.3 |
| 4 | PLA | 96.7 |

### Example 2

Example 2 shows the solubility of diverters in 15% aqueous HCl solution at various temperatures. The following tests were done using digestion vessels at different temperatures. The solutions were prepared by addition of 16 mL of 15% HCl and 1 g of sample. After heating for the desired time, the solution was left to cool at room temperature (“RT”). The solution was then filtrated through a 41 Whatman paper and washed over no more than 50 mL of DI water. The recovered solid material was left to dry. The percent of material in solution was calculated based on the amount of recovered material.

The obtained data is shown in Table 2. At 250° F. all the tested samples were dissolved after 24 hrs including PLA while at 300° F. all the samples were totally dissolved after 4 hours. At 350° F. Aolinex X151A dissolved almost completely after 4 hours. This data shows that these materials can be applied at high temperatures for acid diversion.

TABLE 2
Solubility of diverters in 15% HCL at various temperatures

| | | |
|---|---|---|
| Time (hrs) | Sample | % diverter dissolved |

250° F.

| | | |
|---|---|---|
| 24 | Aonilex X-131A | 100 |
| 24 | PLA | 100 |

300° F.

| | | |
|---|---|---|
| 4 | Aonilex X-131A | 100 |
| 4 | PLA | 100 |
| 24 | Aonilex X-131A | 100 |
| 24 | PLA | 100 |

350° F.

| | | |
|---|---|---|
| 2 | X151A | 10.41 |
| 4 | X151A | 97.5 |

### Example 3

Example 3 shows the solubility of diverters in DI water of mixtures with ultralightweigh proppant (LiteProp 175) at various temperatures. Table 3 shows the solubility data of the diverters when mixed with proppant (LiteProp 175). After 24 hours at 300° F., all the diverter was solubilized.

TABLE 3
Solubility of diverters in DI water of mixtures with ultralight
weigh proppant (LiteProp 175) at various temperatures

| | | | |
|---|---|---|---|
| Time | | % diverter | |
| (hrs) | Sample | dissolved | Comments |

250° F.

| | | | |
|---|---|---|---|
| 24 | Aonilex X-131A/LiteProp 175 | 8.4 | Clear solution |

300° F.

| | | | |
|---|---|---|---|
| 24 | Aonilex X-131A/LiteProp 175 | 83.2 | Only proppant left |
| 24 | Aonilex X-151A/LiteProp 175 | 82.2 | Only proppant left |

350° F.

| | | | |
|---|---|---|---|
| 4 | Aonilex X-131A/LiteProp 175 | 3.54 | clear solution |
| 4 | Aonilex X-151A/LiteProp 175 | 2.97 | clear solution |
| 4 | PLA/LiteProp 175 | 99.6 | Only proppant left |

### Example 4

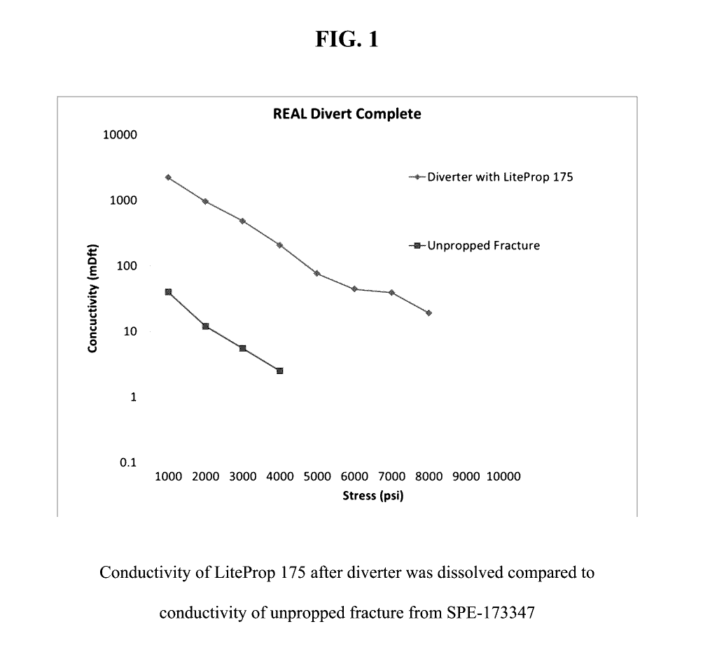

In Example 4, the conductivity data of a mixture of LiteProp 175 with PLA was measured at 275° F. The testing was done accordingly to ISO-13503-5. The conductivity of LiteProp 175 after the diverter was dissolved was compared to the conductivity of an unpropped fracture as described in SPE-173347 (Society of Petroleum Engineers—2015). FIG. 1 shows that, when using the mixture of dissolvable particles with LiteProp 175, the conductivity is orders of magnitudes larger than that of the unpropped fracture.

It is to be understood that any recitation of numerical ranges by endpoints includes all numbers subsumed within the recited ranges as well as the endpoints of the range. It is also to be understood that the presently disclosed subject matter is not to be limited to the exact details of construction, operation, exact materials, or embodiments shown and described, as obvious modifications and equivalents will be apparent to one skilled in the art. Accordingly, the presently disclosed subject matter is therefore to be limited only by the scope of the appended claims.

What is claimed is:

1. A method of stimulating a subterranean formation penetrated by a reservoir, the method comprising: introducing into the reservoir a fluid comprising a biodegradable copolymer having the general formula of repeating units [—CHR—CH₂—CO—O—] wherein R represents an alkyl group represented by CₙH₂ₙ₊₁, and n is 1 and 3.

2. The method of claim 1, wherein the biodegradable copolymer is a copolymer of 3-hydroxybutyrate having at least one monomer of hydroxyhexanoate.

3. The method of claim 2, wherein the copolymer is poly-3-hydroxybutyrate-co-3-hydroxyhexanoate.

4. The method of claim 1, wherein the downhole temperature of the reservoir is greater than about 250° F.

5. The method of claim 4, wherein the downhole temperature of the reservoir is greater than about 275° F.

6. The method of claim 1, wherein the biodegradable polymer is in particulate form and has a particulate size distribution in the range from about 4 mesh to about 140 mesh.

7. A method of stimulating the production of hydrocarbons from a subterranean formation penetrated by a wellbore, the method comprising:
flowing into a high permeability zone of a fracture within a subterranean formation near the wellbore a mixture comprising a dissolvable diverter and a proppant, wherein the dissolvable diverter comprises a biodegradable copolymer having the general formula of repeating units [—CHR—CH₂—CO—O—] wherein R represents an alkyl group represented by CₙH₂ₙ₊₁, and n is 1 and 3;
propping open at least a portion of the high permeability zone with the proppant of the mixture and blocking at least a portion of the high permeability zone with the diverter;
pumping a fluid into the subterranean formation and into a lower permeability zone of the formation farther from the wellbore;
dissolving the diverter blocking at least a portion of the high permeability zone near the wellbore, while the proppant remains present within the high permeability zone; and
producing hydrocarbons from the high permeability zone and the lower permeability zone.

8. The method of claim 7, wherein the biodegradable copolymer is a copolymer of 3-hydroxybutyrate having at least one monomer of hydroxyhexanoate.

9. The method of claim 8, wherein the copolymer is poly-3-hydroxybutyrate-co-3-hydroxyhexanoate.

10. The method of claim 7, wherein the downhole temperature of the reservoir is greater than about 250° F.

11. The method of claim 10, wherein the downhole temperature of the reservoir is greater than about 275° F.

12. The method of claim 7, wherein the biodegradable polymer is in particulate form and has a particulate size distribution in the range from about 4 mesh to about 140 mesh.

13. The method of claim 7, wherein the weight percent of proppant in the mixture is in the range from 2% to 90%.

14. The method of claim 7, wherein the weight percent of proppant in the mixture is in the range from 4% to 70%.

15. The method of claim 7, wherein the dissolvable diverter and the proppant are in particulate form, and wherein at least some of the dissolvable diverter particulates are larger than the proppant particulates, and wherein the size distribution of the dissolvable diverter particulates and the proppant particulates is sufficient to minimize permeability.

16. A method of enhancing the productivity of fluid from a well penetrating a subterranean formation, the method comprising:
pumping into the subterranean formation at a pressure sufficient to create or enhance a fracture near the wellbore a first fluid, the first fluid comprising a mixture of a diverter and a proppant wherein the diverter is dissolvable at in-situ conditions for producing fluid from the well, and wherein the diverter comprises a biodegradable copolymer having the general formula of repeating units [—CHR—CH2-CO—O—] wherein R represents an alkyl group represented by CnH2n+1, and n is 1 and 3;
flowing the first fluid into a high permeability zone of the fracture, propping at least a portion of the high permeability zone with the proppant of the mixture and blocking at least a portion of the high permeability zone with the diverter;
pumping a second fluid into the subterranean formation and into a lower permeability zone of the subterranean formation farther from the wellbore;
dissolving the diverter blocking at least a portion of the high permeability zone near the wellbore at in-situ reservoir conditions, while the proppant remains present within the high permeability zone; and
producing fluid from the high permeability zone and the lower permeability zone.

17. The method of claim 16, wherein the biodegradable copolymer is a copolymer of 3-hydroxybutyrate having at least one monomer of hydroxyhexanoate.

18. The method of claim 17, wherein the copolymer is poly-3-hydroxybutyrate-co-3-hydroxyhexanoate.

19. The method of claim 16, wherein the first fluid is an acidizing fluid.

20. The method of claim 16, wherein the first fluid is a fracturing fluid and further comprises an aqueous carrier fluid, a cross-linkable gel polymer soluble in the aqueous carrier fluid, a cross-linking agent, a linear gel and a surfactant gel.
